(19) United States
(12) Patent Application Publication
(10) Pub. No.: US 2026/0160858 A1
(43) Pub. Date: Jun. 11, 2026

(54) RADAR SYSTEM

(71) Applicant: RichWave Technology Corp., Taipei (TW)

(72) Inventors: Hsiang-Feng Chi, Taipei (TW); Shih-Kai Lin, Taipei (TW)

(73) Assignee: RichWave Technology Corp., Taipei (TW)

(21) Appl. No.: 19/007,563

(22) Filed: Jan. 2, 2025

(30) Foreign Application Priority Data
Dec. 6, 2024 (TW) 113147339

(51) Int. Cl. G01S 7/03; H01Q 21/06

(52) U.S. Cl. CPC G01S 7/032; H01Q 21/065

(57) ABSTRACT

A radar system is provided. The radar system includes transmitting antennas and receiving antennas. The transmitting antennas includes two transmitting antennas. The two transmitting antennas are configured to transmit transmission signals at different times. The receiving antennas includes two receiving antennas. The two receiving antennas are configured to receive reflected signals at different times. There is a vertical spacing in a certain direction and a horizontal spacing in another direction between the two transmitting antennas. There is another vertical spacing in the certain direction and another horizontal spacing in the another direction between the two receiving antennas. The two directions are perpendicular to each other. The vertical spacing between the two transmitting antennas is equal to the vertical spacing between the two receiving antennas. The horizontal spacing between the two transmitting antennas is equal to the horizontal spacing between the two receiving antennas. The spacings are all greater than zero.

### CROSS-REFERENCE TO RELATED APPLICATION

This application claims the priority benefit of Taiwan application serial no. 113147339, filed on Dec. 6, 2024. The entirety of the above-mentioned patent application is hereby incorporated by reference herein and made a part of this specification.

### BACKGROUND

### Technical Field

The disclosure relates to radar technology, and in particular to a radar system.

### Description of Related Art

Radar technology is a means of target detection and tracking. With the rapid development of science and technology, the frequency modulated continuous wave (FMCW) radar has been widely applied to various fields in recent years.

The frequency modulated continuous wave radar transmits a continuous wave with changing frequencies during a frequency sweep period. There is a certain frequency difference between a reflected signal of the continuous wave reflected by an object and a transmission signal of the continuous wave, and a distance between the object and a radar may be determined based on the frequency difference. Since the frequency modulated continuous wave radar may measure the distance and the speed of a moving target, the frequency modulated continuous wave radar has gradually been widely applied to civilian fields such as road vehicle monitoring and recording systems, automobile anti-collision radars, traffic flow detectors, and autonomous driving.

It is worth noting that a frequency modulated continuous wave radar system may use an array antenna to estimate an angle of a reflected signal (also referred to as an angle of arrival (AoA)). When there is a slight change in the distance between the radar system and the object, an obvious change in the phase at the peak value of the spectrum may occur and is especially obvious in the case of a high-frequency signal. Therefore, the angle of arrival may be estimated using the phase change corresponding to the distance difference between the object and the adjacent antennas.

In order to use the array antenna, the current frequency modulated continuous wave radar system for estimating the angle of arrival has a multi-receiver architecture. Multiple receiving antennas may be used to receive the transmission signal and the reflected signal reflected by the object.

However, the traditional angle of arrival radar architecture may encounter the following issues. Multiple reception paths (that is, multiple receivers) are required. Power consumption is increased. As the number of receivers increases, the chip size also increases. Phases of signals from a local oscillator to each receiver, transmitter, and mixing circuit need to be calibrated to improve the consistency of the phases.

### SUMMARY

A radar system of an embodiment of the disclosure includes multiple transmitting antennas and multiple receiving antennas. The transmitting antennas are configured to transmit a transmission signal. The receiving antennas are configured to receive a reflected signal to form a radio frequency signal. The reflected signal is generated by the transmission signal being reflected by an external object. The transmitting antennas include two second transmitting antennas, and the two second transmitting antennas are configured to transmit the transmission signal at different times. The receiving antennas include two receiving antennas, and the two receiving antennas are configured to receive the reflected signal at different times. There is a vertical spacing in a certain direction and a horizontal spacing in another direction between the two transmitting antennas. There is another vertical spacing in the certain direction and another horizontal spacing in the another direction between the two receiving antennas. The two directions are perpendicular to each other, the vertical spacing between the two transmitting antennas is equal to the vertical spacing between the two receiving antennas, and the horizontal spacing between the two transmitting antennas is equal to the horizontal spacing between the two receiving antennas. The vertical spacings and the horizontal spacings are all greater than zero.

A radar system of an embodiment of the disclosure includes a transmitting circuit, multiple transmitting antennas, multiple receiving antennas, a receiving circuit, a control circuit, and a selection circuit. The transmitting circuit is configured to generate a transmission signal. The transmitting antennas are configured to transmit the transmission signal. The receiving antennas are configured to receive a reflected signal to form a radio frequency signal. The reflected signal is generated by the transmission signal being reflected by an external object. The receiving circuit is configured to generate an internal signal according to the radio frequency signal. The control circuit is configured to generate one or more control signals. The selection circuit is configured to receive the one or more control signals and is configured to select one of the transmitting antennas to transmit the transmission signal according to the one or more control signals, and to select one of the receiving antennas to receive the reflected signal to form the radio frequency signal. The transmitting antennas include two transmitting antennas. The receiving antennas include two receiving antennas. There is a vertical spacing in a certain direction and a horizontal spacing in another direction between the two transmitting antennas. There is a vertical spacing in the certain direction and a horizontal spacing in the another direction between the two receiving antennas. The two directions are perpendicular to each other. The vertical spacing between the two transmitting antennas is equal to the vertical spacing between the two receiving antennas. The horizontal spacing between the two transmitting antennas is equal to the horizontal spacing between the two receiving antennas. The vertical spacings and the horizontal spacings are all greater than zero.

A radar system of an embodiment of the disclosure includes a transmitting circuit, multiple transmitting antennas, multiple receiving antennas, a receiving circuit, a control circuit, and a selection circuit. The transmitting circuit is configured to generate a transmission signal. The transmitting antennas are configured to transmit the transmission signal. The receiving antennas are configured to receive multiple reflected signals to form multiple radio frequency signals. The reflected signals are generated by the transmission signal being reflected by an external object. The receiving circuit is configured to generate an internal signal according to the radio frequency signals. The control circuit is configured to generate one or more control signals. The selection circuit is configured to receive the one or more control signals and is configured to select one of the transmitting antennas to transmit the transmission signal according to the one or more control signals. The transmitting antennas include two transmitting antennas. The receiving antennas include two receiving antennas. There is a vertical spacing in a certain direction and a horizontal spacing in another direction between the two transmitting antennas. There is a vertical spacing in the certain direction and a horizontal spacing in the another direction between the two receiving antennas. The two directions are perpendicular to each other. The vertical spacing between the two transmitting antennas is equal to the vertical spacing between the two receiving antennas. The horizontal spacing between the two transmitting antennas is equal to the horizontal spacing between the two receiving antennas. The vertical spacings and the horizontal spacings are all greater than zero.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram of elements of a radar system according to an embodiment of the disclosure.

FIG. 2A to FIG. 2D are schematic diagrams of antenna configurations according to a first embodiment of the disclosure.

FIG. 3 is a schematic diagram of an antenna configuration according to a second embodiment of the disclosure.

FIG. 4 is a schematic diagram of an antenna configuration according to a third embodiment of the disclosure.

FIG. 5 is a schematic diagram of an antenna configuration according to a fourth embodiment of the disclosure.

FIG. 6 is a schematic diagram of an antenna configuration according to a fifth embodiment of the disclosure.

FIG. 7 is a block diagram of elements of a radar system according to an embodiment of the disclosure.

FIG. 8 is a schematic diagram illustrating positional relationship between transmitting antennas and an external object according to an embodiment of the disclosure.

FIG. 9 is a schematic diagram illustrating positional relationship between receiving antennas and an external object according to an embodiment of the disclosure.

FIG. 10 is a timing diagram illustrating signal according to an embodiment of the disclosure.

FIG. 11 is a block diagram of elements of a radar system according to an embodiment of the disclosure.

### DESCRIPTION OF THE EMBODIMENTS

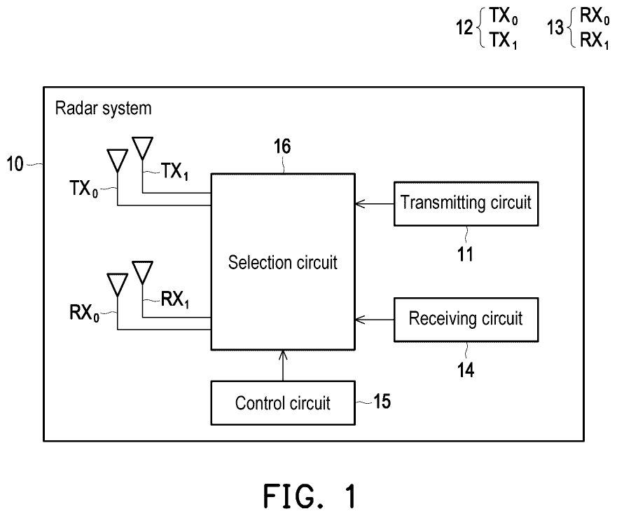

FIG. 1 is a block diagram of elements of a radar system 10 according to an embodiment of the disclosure. Please refer to FIG. 1. The radar system 10 includes (but is not limited to) a transmitting circuit 11, multiple transmitting antennas 12, multiple receiving antennas 13, a receiving circuit 14, a control circuit 15, and a selection circuit 16. The radar system 10 may be, for example, applied to fields such as meteorology, speed measurement, vehicle reversing, terrain, and military affairs.

The transmitting circuit 11 is configured to generate a transmission signal. In an embodiment, the transmitting circuit 11 generates the transmission signal according to a first signal. In an embodiment, the first signal is a continuous wave signal. The first signal has periodic changes. In an embodiment, the frequency of the first signal changes with time during a frequency sweep period thereof. For example, the first signal is a periodic sawtooth wave, triangle wave, or other carrier signals (for example, a linear, geometric, or other chirp signals) applied to a frequency modulated continuous wave. During the period, the frequency of the first signal may gradually increase and/or decrease. In another embodiment, the first signal is a pulse signal. For example, there is a peak or a valley within a specific time interval (for example, 2, 5, or 110 nanoseconds (ns)). After every period, a pulse signal may be generated.

The transmitting antenna 12 is configured to transmit a transmission signal. That is, a transmitted electromagnetic wave carries the transmission signal of the radar system 10. In an embodiment, since the first signal has periodic changes, the transmission signal also correspondingly has periodic changes. In an embodiment, for the pulse signal, the transmission signal is a spread spectrum signal with a flat frequency response in the spectrum.

The transmitting antennas 12 include two transmitting antennas TX₀ and TX₁. The transmitting antenna 12 is, for example, a patch antenna, a ceramic antenna, or other types of antennas. The two transmitting antennas TX₀ and TX₁ are configured to transmit transmission signals at different times.

In an embodiment, the transmitting antennas 12 form an antenna array. In an embodiment, each transmitting antenna 12 may correspond to one antenna port.

The receiving antennas 13 are configured to receive reflected signals. The radar system 10 may transmit the transmission signal to an external object (for example, a person, a car, a wall, or a building) through the transmitting antenna 12. Then, the radar system 10 may receive the reflected signal reflected from the external object through the receiving antenna 13. The reflected signal is generated by the transmission signal being reflected by the external object.

The receiving antennas 13 include two receiving antennas RX₀ and RX₁. The receiving antenna 13 is, for example, a patch antenna, a ceramic antenna, or other types of antennas. The two receiving antennas RX₀ and RX₁ are configured to receive the reflected signals at different times.

In an embodiment, the receiving antennas 13 form an antenna array. In an embodiment, each receiving antenna 13 may correspond to one antenna port.

The receiving circuit 14 is configured to generate an internal signal according to a radio frequency signal. The reflected signal respectively received by the two receiving antennas RX₀ and RX₁ may form the radio frequency signal, which will be described in detail later.

The control circuit 15 is configured to generate one or more control signals. In an embodiment, the one or more control signals change corresponding to the period of the first signal. For example, the control signal may be blocked as a second signal or a third signal, and the difference between the two signals is voltage, current, and/or digital encoding. The first signal is a periodic chirp signal. A period of a combination of one or more chirp signals may be used as the period of the first signal. During a certain period of the first signal, the control signal is the second signal (for example, high level). During another period of the first signal, the control signal is the third signal (for example, low level). Therefore, during different periods of the first signal, the control signals are different. It should be noted that the voltage, the current, and/or the digital encoding of the control signal may be changed according to actual requirements. In addition, the switching or changing time point of the control signal is, for example, at the junction of the two certain periods of the first signal, which will be described in detail in subsequent embodiments.

The selection circuit 16 is coupled to the transmitting circuit 11, the transmitting antenna 12, the receiving antenna 13, the receiving circuit 14, and the control circuit 15.

In an embodiment, the selection circuit 16 is configured to selectively connect one of the transmitting antennas 12 and transmit the transmission signal through the connected transmitting antenna 12 accordingly. For example, the transmitting antenna TX₀ is selected to be connected, and the transmitting antenna TX₁ is disconnected, so that transmitting antenna TX₀ transmits the transmission signal. For another example, the transmitting antenna TX₁ is selected to be connected, and the transmitting antenna TX₀ is disconnected, so that the transmitting antenna TX₁ transmits the transmission signal.

In an embodiment, the selection circuit 16 is configured to selectively connect one of the receiving antennas 13 and receive the reflected signal through the connected receiving antenna 13 accordingly. For example, the receiving antenna RX₀ is selected to be connected, and the receiving antenna RX₁ is disconnected, so that the receiving antenna RX₀ receives the reflected signal. For another example, the receiving antenna RX₁ is selected to be connected, and the receiving antenna RX₀ is disconnected, so that the receiving antenna RX₁ receives the reflected signal.

The antenna configuration is explained in detail below.

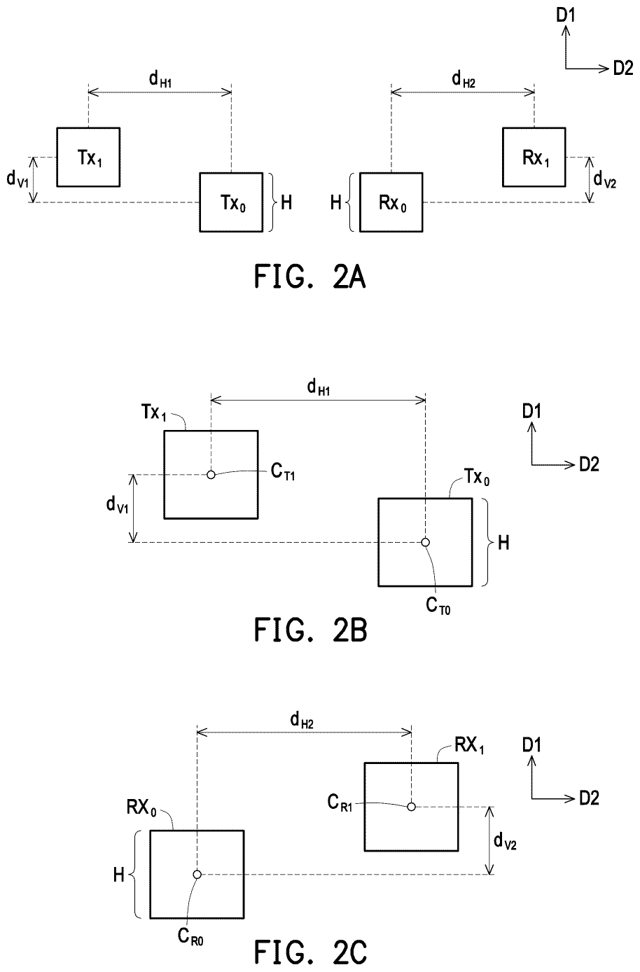

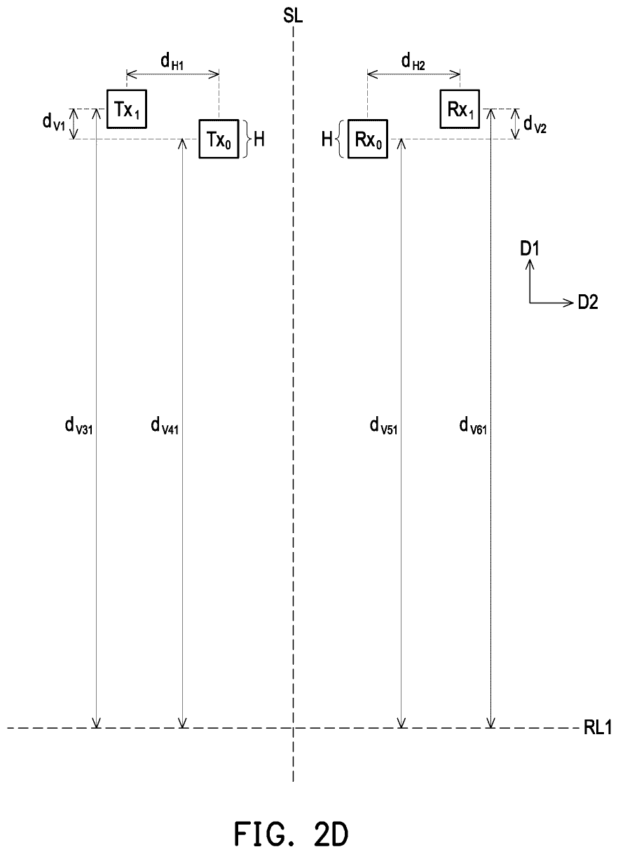

FIG. 2A to FIG. 2D are schematic diagrams of antenna configurations according to a first embodiment of the disclosure. Please refer to FIG. 2A and FIG. 2B. There is a vertical spacing dVi in a direction D1 and a horizontal spacing dm in a direction D2 between the two transmitting antennas TX₀ and TX₁. The direction D1 is perpendicular to the direction D2. For example, the direction D1 is perpendicular to the ground, and the direction D2 is parallel to the ground, but changes may still be made according to the actual application situation. Taking the patch antenna as an example, the transmitting antennas TX₀ and TX₁ are both located on a plane formed by the directions D1 and D2. The sizes of the transmitting antennas TX₀ and TX₁ are, for example, length H×length H, where H is a positive value. However, the sizes of the transmitting antennas TX₀ and TX₁ may still be changed according to actual requirements.

The vertical spacing d_{V1} is greater than zero. In an embodiment, the vertical spacing d_{V1} is less than or equal to λ/2, where λ is the wavelength of the transmission signal. In an embodiment, the vertical spacing d_{V1} is between λ/8 and λ/2, that is, the vertical spacing d_{V1} is less than or equal to λ/2 and the vertical spacing d_{V1} is greater than or equal to λ/8. However, the length of the vertical spacing d_{V1} may still be changed according to actual requirements.

The horizontal spacing d_{H1} is greater than zero. In an embodiment, the horizontal spacing d_{H1} is less than (or equal to) λ/2, where λ is the wavelength of the transmission signal. In an embodiment, the horizontal spacing d_{H1} is between λ/8 and λ/2, that is, the horizontal spacing d_{H1} is less than (or equal to) λ/2 and the horizontal spacing d_{H1} is greater than or equal to λ/8. In an embodiment, the horizontal spacing d_{H1} is greater than the vertical spacing d_{V1}. However, the length of the horizontal spacing d_{H1} may still be changed according to actual requirements.

Please refer to FIG. 2B. The vertical spacing d_{V1} and the horizontal spacing d_{H1} are respectively spacings between a shape center C_{T0} of the transmitting antenna TX₀ and a shape center C_{T1} of the transmitting antenna TX₁ in the direction D1 and the direction D2. The shape centers C_{T0} and C_{T1} are respectively, for example, the geometric centers of the transmitting antennas TX₀ and TX₁.

Please refer to FIG. 2A and FIG. 2C. There is a vertical spacing d_{V2} in the direction D1 and a horizontal spacing d_{H2} in the direction D2 between the two receiving antennas RX₀ and RX₁. Taking the patch antenna as an example, the receiving antennas RX₀ and RX₁ are both located on a plane formed by the directions D1 and D2. The sizes of the receiving antennas RX₀ and RX₁ are, for example, length H×length H, where H is a positive value. However, the sizes of the receiving antennas RX₀ and RX₁ may still be changed according to actual requirements.

The vertical spacing d_{V2} is greater than zero. In addition, the vertical spacing d_{V1} is equal to the vertical spacing d_{V2}, and the vertical spacing d_{V1} and the vertical spacing d_{V2} may be regarded as both being d_{V}. In an embodiment, the vertical spacing d_{V2} is less than or equal to λ/2, where λ is the wavelength of the transmission signal. In an embodiment, the vertical spacing d_{V2} is between λ/8 and λ/2, that is, the vertical spacing d_{V2} is less than or equal to λ/2 and the vertical spacing d_{V2} is greater than or equal to λ/8. However, the length of the vertical spacing d_{V2} may still be changed according to actual requirements.

The horizontal spacing d_{H2} is greater than zero. In addition, the horizontal spacing d_{H1} is equal to the horizontal spacing d_{H2}, and the horizontal spacing di and the horizontal spacing d_{H2} may be regarded as both being du. In an embodiment, the horizontal spacing d_{H2} is less than (or equal to) λ/2, where λ is the wavelength of the transmission signal. In an embodiment, the horizontal spacing d_{H2} is between λ/8 and λ/2, that is, the horizontal spacing d_{H2} is less than (or equal to) λ/2 and the horizontal spacing d_{H2} is greater than or equal to λ/8. In an embodiment, the horizontal spacing d_{H2} is greater than the vertical spacing d_{V2}. However, the length of the horizontal spacing d_{H2} may still be changed according to actual requirements.

Please refer to FIG. 2C. The vertical spacing d_{V2} and the horizontal spacing d_{H2} are respectively spacings between a shape center C_{R0} of the receiving antenna RX₀ and a shape center C_{R1} of the receiving antenna RX₁ in the direction D1 and the direction D2. The shape centers C_{R0} and C_{R1} are respectively, for example, the geometric centers of the receiving antennas RX₀ and RX₁.

Please refer to FIG. 2D. In the direction D1, there is a vertical spacing d_{V31} between the transmitting antenna TX₁ and a reference line RL1, there is a vertical spacing d_{V41} between the transmitting antenna TX₀ and the reference line RL1, the vertical spacing d_{V31} is greater than the vertical spacing d_{V41}, and the reference line RL1 is parallel to the direction D2. In the direction D1, compared with the reference line RL1, the transmitting antennas TX₀ and TX₁ are both located in the positive direction of the direction D1 (the arrow direction of the direction D1), that is, the reference line RL1 is located below the transmitting antennas TX₀ and TX₁, and the reference line RL1 is closer to the transmitting antenna TX₀. The vertical spacings d_{V31} and d_{V41} are both greater than zero. In addition, vertical spacings between the transmitting antennas TX₀ and TX₁ and the reference line RL1 is calculated, for example, based on the shape centers C_{T0} and C_{T1}.

In addition, in the direction D1, there is a vertical spacing d_{V51} between the receiving antenna RX₀ and the reference line RL1, there is a vertical spacing d_{V61} between the receiving antenna RX₁ and the reference line RL1, and the vertical spacing d_{V51} is less than the vertical spacing d_{V61}. In the direction D1, compared with the reference line RL1, the receiving antennas RX₀ and RX₁ are both located in the positive direction of the direction D1 (the arrow direction of the direction D1), that is, the reference line RL1 is located below the receiving antennas RX₀ and RX₁, and the reference line RL1 is closer to the receiving antenna RX₀. The vertical spacings d_{V51} and d_{V61} are both greater than zero. The vertical spacing d_{V31} is equal to the vertical spacing d_{V61}, and the vertical spacing d_{V41} is equal to the vertical spacing d_{V51}. In addition, vertical spacings between the receiving antennas RX₀ and RX₁ and the reference line RL1 are calculated, for example, based on the shape centers C_{R0} and C_{R1}.

The transmitting antennas TX₀ and TX₁ and the receiving antennas RX₀ and RX₁ are mirror symmetrical with respect to a symmetry axis SL, and the symmetry axis SL is parallel to the direction D1. A distance between the transmitting antenna TX₁ and the symmetry axis SL is the same as a distance between the receiving antenna RX₁ and the symmetry axis SL. A distance between the transmitting antenna TX₀ and the symmetry axis SL is the same as a distance between the receiving antenna RX₀ and the symmetry axis SL. An imaginary line between the transmitting antenna TX₀ and the receiving antenna RX₀ is parallel to the direction D2, and an imaginary line between the transmitting antenna TX₁ and the receiving antenna RX₁ is parallel to the direction D2.

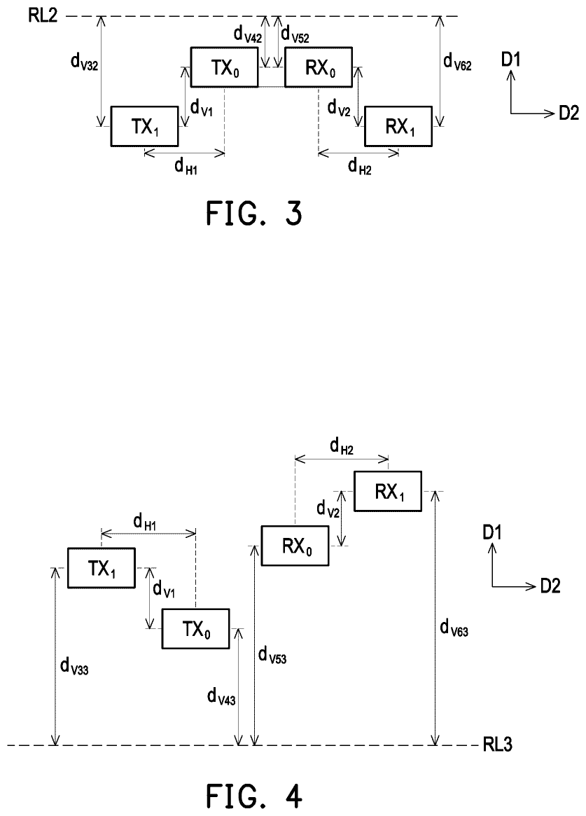

FIG. 3 is a schematic diagram of an antenna configuration according to a second embodiment of the disclosure. Please refer to FIG. 3. The difference from the first embodiment is that in the direction D1, there is a vertical spacing d_{V32} between the transmitting antenna TX₁ and a reference line RL2, there is a vertical spacing d_{V42} between the transmitting antenna TX₀ and the reference line RL2, the vertical spacing d_{V32} is greater than the vertical spacing d_{V42}, and the reference line RL2 is parallel to the direction D2. In the direction D1, compared with the reference line RL2, the transmitting antennas TX₀ and TX₁ are both located in the negative direction of the direction D1 (the opposite direction of the arrow direction of the direction D1), that is, the reference line RL2 is located above the transmitting antennas TX₀ and TX₁, and the reference line RL2 is closer to the transmitting antenna TX₀. The vertical spacings d_{V32} and d_{V42} are both greater than zero. In addition, vertical spacings between the transmitting antennas TX₀ and TX₁ and the reference line RL2 are calculated, for example, based on the shape centers C_{T0} and C_{T1}.

In addition, in the direction D1, there is a vertical spacing d_{V52} between the receiving antenna RX₀ and the reference line RL2, there is a vertical spacing d_{V62} between the receiving antenna RX₁ and the reference line RL2, and the vertical spacing d_{V52} is less than the vertical spacing d_{V62}. In the direction D1, compared with the reference line RL2, the receiving antennas RX₀ and RX₁ are both located in the negative direction of the direction D1 (the opposite direction of the arrow direction of the direction D1), that is, the reference line RL2 is located above the receiving antennas RX₀ and RX₁, and the reference line RL2 is closer to the receiving antenna RX₀. The vertical spacings d_{V52} and d_{V62} are both greater than zero. In addition, vertical spacings between the receiving antennas RX₀ and RX₁ and the reference line RL2 are calculated, for example, based on the shape centers C_{R0} and C_{R1}.

FIG. 4 is a schematic diagram of an antenna configuration according to a third embodiment of the disclosure. Please refer to FIG. 4. The difference from the first embodiment is that in the direction D1, there is a vertical spacing d_{V33} between the transmitting antenna TX₁ and a reference line RL3, there is a vertical spacing d_{V43} between the transmitting antenna TX₀ and the reference line RL3, the vertical spacing d_{V33} is greater than the vertical spacing d_{V43}, and the reference line RL3 is parallel to the direction D2. In the direction D1, compared with the reference line RL3, the transmitting antennas TX₀ and TX₁ are both located in the positive direction of the direction D1 (the arrow direction of the direction D1), that is, the reference line RL3 is located below the transmitting antennas TX₀ and TX₁, and the reference line RL3 is closer to the transmitting antenna TX₀. The vertical spacings d_{V33} and d_{V43} are both greater than zero. In addition, vertical spacings between the transmitting antennas TX₀ and TX₁ and the reference line RL3 are calculated, for example, based on the shape centers C_{T0} and C_{T1}.

In addition, in the direction D1, there is a vertical spacing d_{V53} between the receiving antenna RX₀ and the reference line RL3, there is a vertical spacing d_{V63} between the receiving antenna RX₁ and the reference line RL3, and the vertical spacing d_{V53} is less than the vertical spacing d_{V63}. In the direction D1, compared with the reference line RL3, the receiving antennas RX₀ and RX₁ are both located in the positive direction of the direction D1 (the arrow direction of the direction D1), that is, the reference line RL3 is located below the receiving antennas RX₀ and RX₁, and the reference line RL3 is closer to the receiving antenna RX₀. The vertical spacings d_{V53} and d_{V63} are both greater than zero. The vertical spacing d_{V33} is less than the vertical spacing d_{V63}, and the vertical spacing d_{V43} is less than the vertical spacing d_{V53}. In addition, vertical spacings between the receiving antennas RX₀ and RX₁ and the reference line RL3 are calculated based on, for example, the shape centers C_{R0} and C_{R1}.

In other embodiments, the vertical spacing d_{V33} may be greater than the vertical spacing d_{V63}, and the vertical spacing d_{V43} may be greater than the vertical spacing d_{V53}.

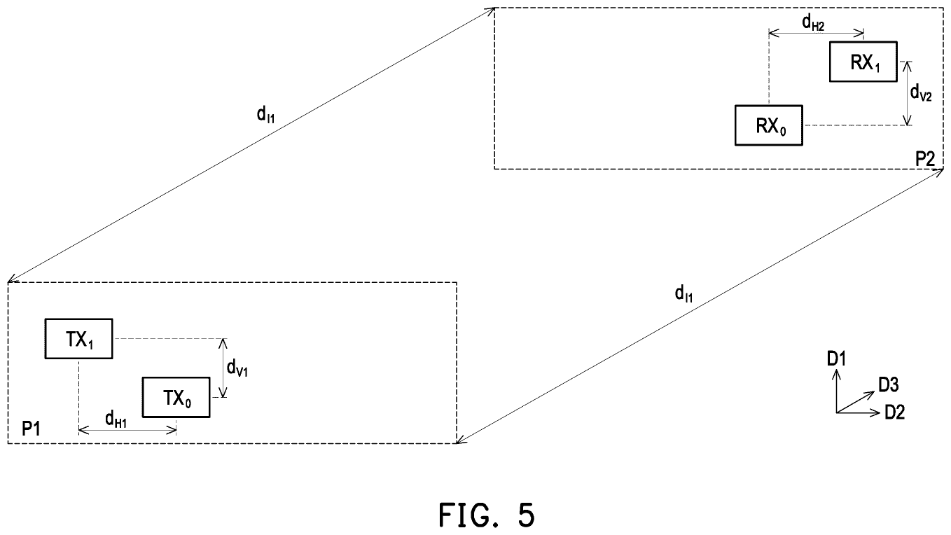

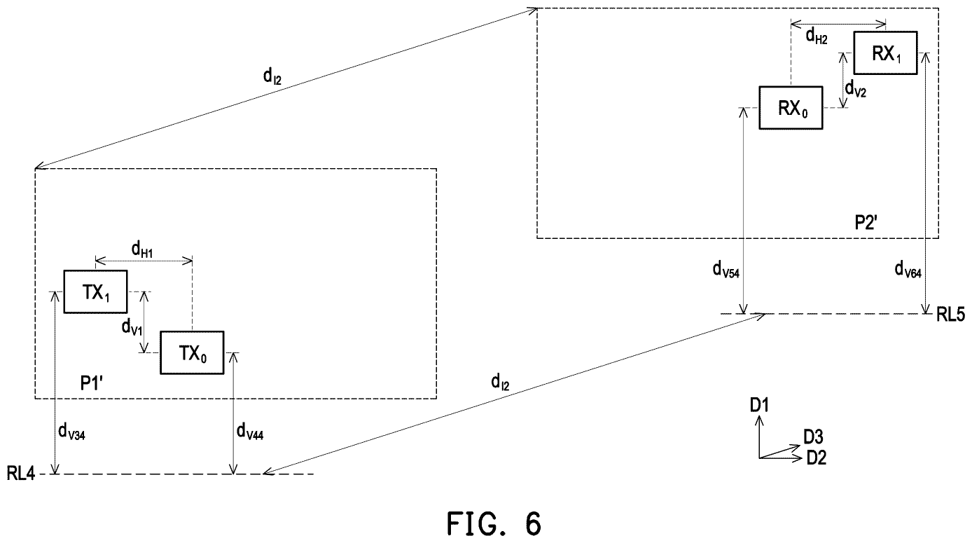

FIG. 5 is a schematic diagram of an antenna configuration according to a fourth embodiment of the disclosure. Please refer to FIG. 5. The difference from the first embodiment is that the transmitting antennas TX₀ and TX₁ are located on a plane P1, and the receiving antennas RX₀ and RX₁ are located on a plane P2. The planes P1 and P2 are both parallel to the plane formed by the directions D1 and D2. A spacing dn between the plane P1 and the plane P2 in the direction D3 is greater than zero, and the direction D3 is respectively perpendicular to the direction D1 and the direction D2. That is, there is the distance du between the transmitting antennas TX₀ and TX₁ and the receiving antennas RX₀ and RX₁ in the direction D3.

FIG. 6 is a schematic diagram of an antenna configuration according to a fifth embodiment of the disclosure. Please refer to FIG. 6. The difference from the first embodiment is that the transmitting antennas TX₀ and TX₁ are located on a plane P1′, and the receiving antennas RX₀ and RX₁ are located on a plane P2′. The planes P1′ and P2′ are both parallel to the plane formed by the directions D1 and D2. A spacing dp between the plane P1′ and the plane P2′ in the direction D3 is greater than zero, and the direction D3 is respectively perpendicular to the direction D1 and the direction D2. That is, there is the distance de between the transmitting antennas TX₀ and TX₁ and the receiving antennas RX₀ and RX₁ in the direction D3.

In the direction D1, there is a vertical spacing d_{V34} between the transmitting antenna TX₁ and a reference line RL4, there is a vertical spacing d_{V44} between the transmitting antenna TX₀ and the reference line RL4, the vertical spacing d_{V34} is greater than the vertical spacing d_{V44}, and the reference line RL4 is parallel to the direction D2. In the direction D1, compared with the reference line RL4, the transmitting antennas TX₀ and TX₁ are both located in the positive direction of the direction D1 (the arrow direction of the direction D1), that is, the reference line RL4 is located below the transmitting antennas TX₀ and TX₁, and the reference line RL4 is closer to the transmitting antenna TX₀. The vertical spacings d_{V34} and d_{V44} are both greater than zero. In addition, vertical spacings between the transmitting antennas TX₀ and TX₁ and the reference line RL4 are calculated, for example, based on the shape centers C_{T0} and C_{T1}.

In addition, in the direction D1, there is a vertical spacing d_{V54} between the receiving antenna RX₀ and a reference line RL5, there is a vertical spacing d_{V64} between the receiving antenna RX₁ and the reference line RL5, and the vertical spacing d_{V54} is less than the vertical spacing d_{V64}. In the direction D1, compared with the reference line RL5, the receiving antennas RX₀ and RX₁ are both located in the positive direction of the direction D1 (the arrow direction of the direction D1), that is, the reference line RL5 is located below the receiving antennas RX₀ and RX₁, and the reference line RL5 is closer to the receiving antenna RX₀. The vertical spacings d_{V54} and d_{V64} are both greater than zero. The vertical spacing d_{V34} is less than the vertical spacing d_{V64}, and the vertical spacing d_{V44} is less than the vertical spacing d_{V54}. In addition, vertical spacings between the receiving antennas RX₀ and RX₁ and the reference line RL5 are calculated, for example, based on the shape centers C_{R0} and C_{R1}. Furthermore, a spacing d_{I2} between the reference line RLA and the reference line RL5 in the direction D3 is also greater than zero.

In other embodiments, the vertical spacing d_{V34} may be greater than the vertical spacing d_{V64} and the vertical spacing d_{V44} may be greater than the vertical spacing d_{V54}.

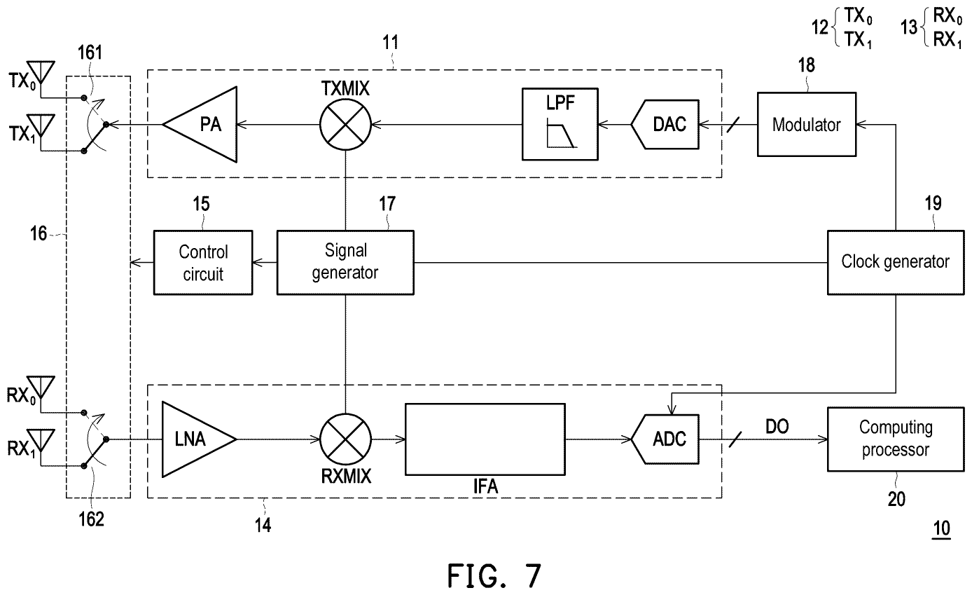

The detailed hardware architecture of the radar system 10 will be described in more detail below with reference to FIG. 7.

FIG. 7 is a block diagram of elements of the radar system 10 according to an embodiment of the disclosure. Please refer to FIG. 7. The radar system 10 may include (but is not limited to) the transmitting circuit 11, the transmitting antennas TX₀, TX₁, the receiving antennas RX₀, RX₁, the receiving circuit 14, the control circuit 15, and the selection circuit 16. In addition, the radar system 10 may also include (but is not limited to) a signal generator 17, a modulator 18, a clock generator 19, and a computing processor 20.

The transmitting circuit 11 includes an amplifier PA and a mixer TXMIX. The amplifier PA is coupled to the mixer TXMIX. The amplifier PA is configured to amplify a signal (for example, an output signal of the mixer TXMIX). The mixer TXMIX is configured to mix a signal to generate a transmission signal. In addition, the transmitting circuit 11 may also include (but is not limited to) a filter LPF and a digital-to-analog converter DAC.

Reference may be respectively made to the description of FIG. 1 to FIG. 6 for the introduction of the transmitting antennas TX₀, TX₁ and the receiving antennas RX₀, RX₁, which will not be repeated here.

The receiving circuit 14 includes a low-noise amplifier LNA and a mixer RXMIX. The low-noise amplifier LNA is coupled to the mixer RXMIX. The low-noise amplifier LNA is configured to amplify a signal (for example, a reflected signal). The mixer RXMIX is configured to mix a signal (for example, an output signal of the low-noise amplifier LNA) to generate an intermediate frequency signal. In addition, the receiving circuit 14 may also include (but is not limited to) an intermediate frequency amplifying circuit IFA and an analog-to-digital converter ADC.

Reference may be made to the description of FIG. 1 for the introduction of the control circuit 15, which will not be repeated here.

In an embodiment, the selection circuit 16 is configured to selectively connect one of the transmitting antennas 12. Taking FIG. 7 as an example, the selection circuit 16 of the radar system 10 further includes a switching circuit 161. The switching circuit 161 may be composed of one or more electrical elements such as multiplexers and switches, which are not limited in the embodiment of the disclosure.

In an embodiment, the switching circuit 161 may switch between the two transmitting antennas TX₀ and TX₁ to transmit the transmission signal generated by the transmitting circuit 11 to the transmitting antenna TX₀ or the transmitting antenna TX₁.

In an embodiment, the selection circuit 16 is configured to selectively connect one of the receiving antennas 13. Taking FIG. 7 as an example, the selection circuit 16 of the radar system 10 includes a switching circuit 162. The switching circuit 162 may be composed of one or more electrical elements such as multiplexers and switches, which are not limited in the embodiment of the disclosure.

In an embodiment, the switching circuit 162 may switch between the two receiving antennas RX₀ and RX₁ to transmit the reflected signals respectively received by the two receiving antennas RX₀ and RX₁ to the receiving circuit 14.

In an embodiment, the selection circuit 16 may also disable the unused transmitting antenna among the transmitting antennas TX₀ and TX₁ and/or disable the unused receiving antenna among the receiving antennas RX₀ and RX₁ to achieve the purpose of selective connection.

The signal generator 17 is coupled to the transmitting circuit 11, the receiving circuit 14, and the control circuit 15. In an embodiment, the control circuit 15 is coupled to the transmitting circuit 11 by the signal generator 17. In another embodiment, the control circuit 15 is directly connected to the transmitting circuit 11.

In the embodiment, the signal generator 17 is, for example, a frequency synthesizer and is configured to generate a continuous wave signal. In another embodiment, the signal generator 17 may also be a pulse generator and is configured to generate a pulse signal.

The signal generator 17 is configured to generate the first signal, and provide the first signal to the transmitting circuit 11, the receiving circuit 14, and the control circuit 15. In the embodiment, the first signal is, for example, the continuous wave signal.

The modulator 18 may be implemented through an N-order (where N is a positive integer greater than zero) oversampling modulator or an N-bit Nyquist frequency sampler.

The clock generator 19 is coupled to the signal generator 17, the modulator 18, and the analog-to-digital converter ADC. The clock generator 19 is configured to generate a clock signal (or a local oscillation signal). The signal generator 17 generates the periodic first signal according to the clock signal. The control circuit 15 synchronizes the first signal according to the clock signal. Furthermore, the above situation of synchronizing the first signal may be regarded as the one or more control signals lasting a constant time and the period of the first signal having a fixed overlapping range. For example, the switching or changing period of the control signal may be the same as the period of the first signal, the switching or changing time point of the control signal may be synchronized with the starting point or the end point of the period of the first signal shifted forward by a predetermined time or shifted backward by the predetermined time, or the switching or changing time point of the control signal may be synchronized with the starting point or the end point of the period of the first signal.

The modulator 18 oversamples and modulates the clock signal to generate a digital signal similar to a sine wave, and drives the digital-to-analog converter DAC to generate an analog sine wave signal. Then, the filter LPF performs low-pass filtering on the analog sine wave signal to form a sine wave signal that is input into the mixer TXMIX. The mixer TXMIX mixes (such as up converting) the sine wave signal according to the first signal (for example, the continuous wave signal) from the signal generator 17 to form a transmission signal.

The transmission signal is transmitted through the transmitting antenna 12. Taking FIG. 7 as an example, the transmission signal is transmitted through the transmitting antenna TX₀ or TX₁ that is conducted/switched by the switching circuit 162.

On the other hand, the reflected signal is received through the receiving antenna 13. Taking FIG. 7 as an example, the reflected signal is received through the receiving antenna RX₀ or RX₁ that is conducted/switched by the switching circuit 162. The low-noise amplifier LNA amplifies the reflected signal received by the receiving antenna RX₀ or RX₁, and the mixer RXMIX mixes (such as down converting) the amplified signal according to the first signal (for example, the continuous wave signal) generated by the signal generator 17 to generate an intermediate frequency signal. The intermediate frequency amplifying circuit IFA is configured to perform functions such as amplifying the intermediate frequency signal and filtering.

The computing processor 20 is coupled to the receiving circuit 14. More specifically, the computing processor 20 is coupled to the analog-to-digital converter ADC in the receiving circuit 14 and receives a fundamental frequency signal DO. The computing processor 20 may be a chip, a processor, a microcontroller, an application-specific integrated circuit (ASIC), or any type of digital circuit.

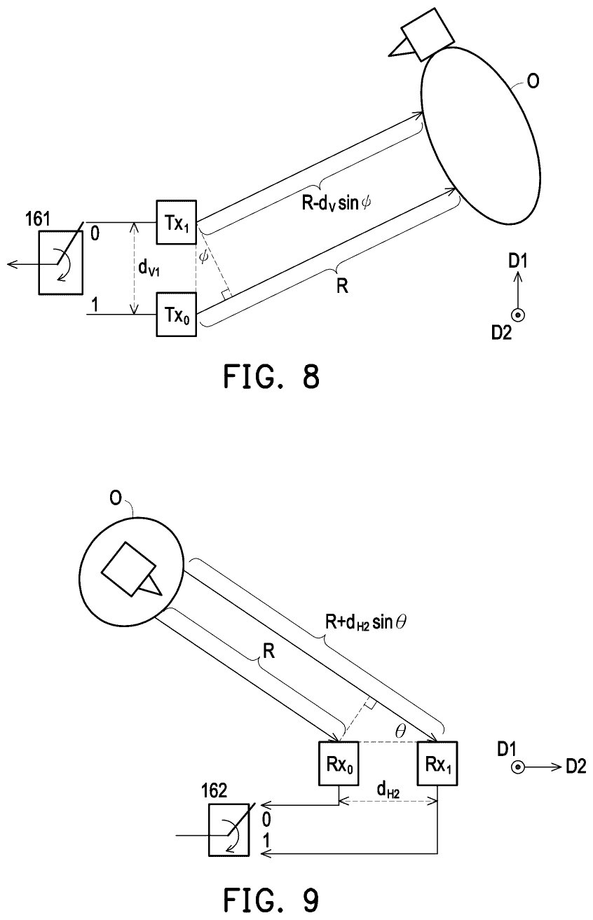

FIG. 8 is a schematic diagram illustrating positional relationship between the transmitting antennas TX₀ and TX₁ and an external object O according to an embodiment of the disclosure. Please refer to FIG. 8. The radar system 10 may transmit the transmission signals to the external object O (also referred to as a target) through the transmitting antennas TX₀ and TX₁. In the direction D1, there is the vertical spacing d_{V1} between the two transmitting antennas TX₀ and TX₁, and the vertical spacing d_{V1} may be regarded as d_{V}. Assuming that a propagation distance of the transmission signal starting from the transmitting antenna TX₀ and arriving at the external object O is a distance R, a propagation distance of the transmission signal starting from the transmitting antenna TX₁ and arriving at the external object O is a distance R-d_{V} sin φ. The angle φ is an included angle between a wave ray of the transmission signal propagating from the transmitting antenna TX₀ or TX₁ to the external object O and the direction D1.

FIG. 9 is a schematic diagram illustrating positional relationship between the receiving antennas RX₀ and RX₁ and the external object O according to an embodiment of the disclosure. Please refer to FIG. 8. The radar system 10 may receive the reflected signal reflected from the external object O (also referred to as the target) through the receiving antenna RX₀ or RX₁. In the direction D2, there is the horizontal spacing d_{H2} between the two receiving antennas RX₀ and RX₁, and the horizontal spacing d_{H2} may be regarded as d_{H}. Assuming that a propagation distance of the reflected signal starting from the external object O and arriving at the transmitting antenna RX₀ is a distance R, a propagation distance of the reflected signal starting from the external object O and arriving at the receiving antenna RX₁ is a distance R+d_{H} sin θ. The angle of arrival (AoA) θ is an included angle between a wave ray of the reflected signal propagating from the external object O to the receiving antenna RX₀ or RX₁ and the direction D2.

Please refer to FIG. 8 and FIG. 9. The transmitting antenna TX₀ transmits the continuous wave signal of one frame (corresponding to one or more periods). Through respectively performing two-dimensional fast Fourier transform (FFT) on fundamental frequency signals corresponding to the two receiving antennas RX₀ and RX₁, two peak values at the same distance (corresponding to the position of the external object) but in different phases may be obtained. Then, a phase difference (ω) between the two peak values may be used to estimate the angle of arrival θ of the external object:

$$ω = \frac{2 π {d}_{H 2} sin ( θ )}{λ} \qquad ( 1 )$$

$$θ = {sin}^{- 1} ( \frac{λ ω}{2 π {d}_{H 2}} ) , \qquad ( 2 )$$

where λ is the wavelength, and d_{H2} is the horizontal spacing between the two receiving antennas RX₀ and RX₁.

In an embodiment, one frame time includes multiple transmission and reception periods, and the transmission and reception periods correspond to the periods of the first signal and/or the transmission signal.

In an embodiment, the selection circuit 16 is configured to receive the one or more control signals and is configured to select one of the transmitting antennas 12 according to the one or more control signals to transmit the transmission signal, and select one of the receiving antennas 13 to receive the reflected signal to form the radio frequency signal.

Taking FIG. 8 as an example, the control signal for the transmitting antenna TX₀ is coded as “0” and indicates that only the transmitting antenna TX₀ is conducted/selected/used (the transmission signal is only transmitted via the transmitting antenna TX₀). The control signal for the transmitting antenna TX₁ is coded as “1” and indicates that only the transmitting antenna TX₁ is conducted/selected/used (the transmission signal is transmitted only via the transmitting antenna TX₁). When the control signal is “0”, the switching circuit 161 switches to the transmitting antenna TX₀. When the control signal is “1”, the switching circuit 161 switches to the transmitting antenna TX₁.

Taking FIG. 9 as an example, the control signal for the receiving antenna RX₀ is coded as “0” and indicates that only the receiving antenna RX₀ is conducted/selected/used (only the reflected signal via the receiving antenna RX₀ is received by the receiving circuit 14 and the signal transmitted to the receiving circuit 14 by the receiving antenna RX₁ is interrupted). The control signal for the receiving antenna RX₁ is coded as “1” and indicates that only the receiving antenna RX₁ is conducted/selected/used (only the reflected signal via the receiving antenna RX₁ is received by the receiving circuit 14 and the signal transmitted to the receiving circuit 14 by the receiving antenna RX₀ is interrupted). When the control signal is “0”, the switching circuit 162 switches to the receiving antenna RX₀. When the control signal is “1”, the switching circuit 162 switches to the receiving antenna RX₁.

Please refer to FIG. 7. The amplifier PA is coupled to one of the transmitting antennas 12 according to the one or more control signals via the selection circuit 16. For example, the switching circuit 161 is switched to the transmitting antenna TX₀, so that the amplifier PA is coupled to the transmitting antenna TX₀. Alternatively, the switching circuit 161 is switched to the transmitting antenna TX₁, so that the amplifier PA is coupled to the transmitting antenna TX₁. In addition, the low-noise amplifier LNA is coupled to one of the receiving antennas 13 according to the one or more control signals via the selection circuit 16. For example, the switching circuit 162 is switched to the receiving antenna RX₀, so that the low-noise amplifier LNA is coupled to the receiving antenna RX₀. Alternatively, the switching circuit 162 is switched to the receiving antenna RX₁, so that the low-noise amplifier LNA is coupled to the receiving antenna RX₁.

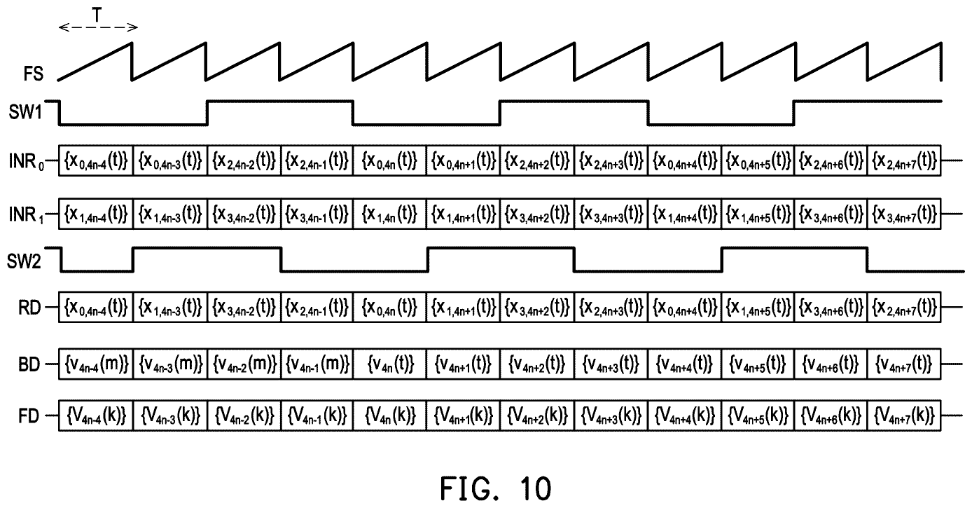

Please refer to FIG. 10. The period of the signal corresponding to any level or code (for example, high level, low level, “0”, or “1”) of the control signal SW1 or SW2 corresponds to the period of the first signal or the transmission signal. For example, one level or code corresponds to a first signal FS of one sawtooth wave. The switching time of two adjacent codes of the control signal SW1 or SW2 is, for example, located at the starting point, the end point, or the ending point of the period of the first signal FS. Alternatively, the switching time of two adjacent codes of the control signal SW1 or SW2 may also be located at the starting point, the end point, or the ending point of the period of the first signal FS shifted forward by a predetermined time or shifted backward by a predetermined time. As shown in FIG. 7, the transmission signal is generated according to the control signal, the control signal is generated according to the first signal generated by the signal generator 17, and the first signal is generated according to the clock signal provided by the clock generator 19. Therefore, the switching time point and the period of the control signal may both be synchronized with the first signal and the transmission signal.

In an embodiment, one frame time includes multiple transmission and reception periods, and the transmission and reception periods correspond to the periods of the first signal and/or the transmission signal.

For example, FIG. 10 is a timing diagram illustrating signal according to an embodiment of the disclosure. Please refer to FIG. 10. The first signal is, for example, the continuous wave signal and is expressed in the form of the chirp signal (frequency changes with time). However, in the embodiment, the period of the first signal is, for example, a frequency changing period of the first signal. The continuous wave signal mixes the sine wave signal and forms the transmission signal accordingly. The first signal FS as the example is presented as a sawtooth wave with frequency changes. During one frequency sweep period T of the sawtooth wave, the frequency increases/rises with time in the rising section, and the frequency directly drops to the trough in the falling section. One frame time includes, for example, four transmission and reception periods. Each transmission and reception period may, for example, include one period of the first signal FS. That is, each transmission and reception period is, for example, one frequency sweep period T of the sawtooth wave. However, there may be other changes in the numerical ratio of frame time to transmission and reception period to frequency sweep period.

In an embodiment, the selection circuit 16 is configured to select only one of the transmitting antennas 12 to transmit the transmission signal during each transmission and reception period in the frame time according to the one or more control signals, and select only one of the receiving antennas to receive the reflected signal during each transmission and reception period in the frame time. Taking FIG. 10 as an example, the control signal SW1 for the transmitting antenna 12 may be at a low level (for example, corresponding to code “0”) and indicates that only the transmitting antenna TX₀ is conducted/selected/used. The control signal SW1 for the transmitting antenna 12 may be at a high level (for example, corresponding to code “1”) and indicates that only the transmitting antenna TX₁ is conducted/selected/used. On the other hand, the control signal SW2 for the receiving antenna 13 may be at a low level (for example, corresponding to code “0”) and indicates that only the receiving antenna RX₀ is conducted/selected/used. The control signal SW2 for the receiving antenna 13 may be at a high level (for example, corresponding to code “1”) and indicates that only the receiving antenna RX₁ is conducted/selected/used.

Please refer to FIG. 10. The frame time includes a first transmission and reception period, a second transmission and reception period, a third transmission and reception period, and a fourth transmission and reception period. The selection circuit 16 is configured to select the transmitting antenna TX₀ (corresponding to the control signal SW1 at the low level) and the receiving antenna RX₀ (corresponds to the control signal SW2 at the low level) during the first transmission and reception period (corresponding to the frequency sweep period T of the first sawtooth wave from the left), select the transmitting antenna TX₀ (corresponding to the control signal SW1 at the low level) and the receiving antenna RX₁ (corresponding to the control signal SW2 at the high level) during the second transmission and reception period (corresponding to the frequency sweep period T of the second sawtooth wave from the left), select the transmitting antenna TX₁ (corresponding to the control signal SW1 at the high level) and the receiving antenna RX₁ (corresponding to the control signal SW2 at the high level) during the third transmission and reception period (corresponding to the frequency sweep period T of the third sawtooth wave from the left), and select the transmitting antenna TX₁ (corresponding to the control signal SW1 at the high level) and the receiving antenna RX₀ (corresponding to the control signal SW2 at the low level) during the fourth transmission and reception period (corresponding to the frequency sweep period T of the fourth sawtooth wave from the left) according to the one or more control signals.

Please refer to FIG. 7 and FIG. 10. The internal signal generated by the receiving circuit 14 according to the radio frequency signal includes a first internal signal, a second internal signal, a third internal signal, and a fourth internal signal. The receiving circuit 14 generates the first internal signal corresponding to the first transmission and reception period, the receiving circuit 14 generates the second internal signal corresponding to the second transmission and reception period, the receiving circuit 14 generates the third internal signal corresponding to the third transmission and reception period, and the receiving circuit 14 generates the fourth internal signal corresponding to the fourth transmission and reception period.

More specifically, during the first transmission and reception period, the switching circuit 162 selects a radio frequency signal INR₀ from the radio frequency signal INR₀ (for example, the mathematical expression is x_{0,4n-4} (t)) received by the receiving antenna RX₀ and a radio frequency signal INR₁ (for example, the mathematical expression is x_{1,4n-4} (t)) received by the receiving antenna RX₁, and outputs a selected radio frequency signal RD (equal to x_{0,4n-4} (t)), where n is a positive integer. The receiving circuit 14 generates an internal signal BD (for example, the mathematical expression is v₄ₙ₋₄ (m) corresponding to the time domain) and an internal signal FD (for example, the mathematical expression is v₄ₙ₋₄ (k) corresponding to the frequency domain) according to the radio frequency signal RD. During the second transmission and reception period, the switching circuit 162 selects the radio frequency signal INR₁ from the radio frequency signal INR₀ (for example, the mathematical expression is x_{0,4n-3} (t)) received by the receiving antenna RX₀ and the radio frequency signal INR₁ (for example, the mathematical expression is x_{1,4n-3} (t)) received by the receiving antenna RX₁, and outputs the selected radio frequency signal RD (equal to x_{1,4n-3} (t)). The receiving circuit 14 generates the internal signal BD (for example, the mathematical expression is v₄ₙ₋₁ (m) corresponding to the time domain) and the internal signal FD (for example, the mathematical expression is v₄ₙ₋₃ (k) corresponding to the frequency domain) according to the radio frequency signal RD. During the third transmission and reception period, the switching circuit 162 selects the radio frequency signal INR₁ from the radio frequency signal INR₀ (for example, the mathematical expression is x_{2,4n-2} (t)) received by the receiving antenna RX₀ and the radio frequency signal INR₁ (for example, the mathematical expression is x_{3,4n-2} (t)) received by the receiving antenna RX₁, and outputs the selected radio frequency signal RD (equal to x_{3,4n-2} (t)). The receiving circuit 14 generates the internal signal BD (for example, the mathematical expression is v₄ₙ₋₂ (m) corresponding to the time domain) and the internal signal FD (for example, the mathematical expression is v₄ₙ₋₂ (k) corresponding to the frequency domain) according to the radio frequency signal RD. During the fourth transmission and reception period, the switching circuit 162 selects the radio frequency signal INR₀ from the radio frequency signal INR₀ (for example, the mathematical expression is x_{2,4n-1} (t)) received by the receiving antenna RX₀ and the radio frequency signal INR₁ (for example, the mathematical expression is x_{3,4n-1} (t)) received by the receiving antenna RX₁, and outputs the selected radio frequency signal RD (equal to x_{2,4n-1} (t)). The receiving circuit 14 generates the internal signal BD (for example, the mathematical expression is v₄ₙ₋₁ (m) corresponding to the time domain) and the internal signal FD (for example, the mathematical expression is V₄ₙ₋₁ (k) corresponding to the frequency domain) according to the radio frequency signal RD.

The computing processor 20 is configured to determine spatial information of the external object according to the first internal signal, the second internal signal, the third internal signal, and the fourth internal signal. In an embodiment, the spatial information of the external object includes movement information, such as the movement information in the direction D1 shown in FIG. 8 or the movement information in the direction D2 shown in FIG. 9. The movement information is position change between two time points and may include a relative distance and a relative direction between positions at the two time points. The computing processor 20 may obtain spectrum information of the fundamental frequency signal DO corresponding to different internal signals through fast Fourier transform or other time domain to frequency domain conversion. The amplitude of the spectrum information corresponds to distance information. The spectrum information takes a power spectrum diagram as an example. Assuming that the reflected signal is obtained through being reflected by an external object, each internal signal has a peak value at the position of the external object (or a distance from the external object). If the peak value corresponding to any distance is greater than an amplitude threshold, the external object is determined to be present, and the distance information (for example, the distance R of FIG. 8 or FIG. 9) is determined accordingly.

Taking FIG. 2D and FIG. 8 to FIG. 10 as examples, the vertical spacing d_{V1} and the vertical spacing d_{V2} may be regarded as both being d_{V}, and the horizontal spacing d_{H1} and the horizontal spacing d_{H2} may be regarded as both being d_{H}. A round-trip distance from the transmitting antenna TX₀ to the external object and arriving at the receiving antenna RX₀ during the first transmission and reception period is 2R, a round-trip distance from the transmitting antenna TX₀ to the external object and arriving at the receiving antenna RX₁ during the second transmission and reception period is 2R+d_{H} sin θ-d_{V} sin φ, a round-trip distance from the transmitting antenna TX₁ to the external object and arriving at the receiving antenna RX₁ during the third transmission and reception period is 2R+2d_{H} sin θ, and a round-trip distance from the transmitting antenna TX₁ to the external object and arriving at the receiving antenna RX₀ during the fourth transmission and reception period is 2R+d_{H} sin θ+d_{V} sin φ. The movement information may be obtained from the distance change between the two time points. For example, a phase difference between the radio frequency signal x_{1,4n-3} (t) and the radio frequency signal x_{2,4n-1} (t) in the direction D1 is 2d_{V} sin φ or a phase difference between the radio frequency signal x_{0,4n-4} (t) and the radio frequency signal x_{3,4n-2} (t) in the direction D2 is 2d_{H} sin θ. On the other hand, taking FIG. 3 and FIG. 8 to FIG. 10 as examples, the vertical spacing d_{V1} and the vertical spacing d_{V2} may be regarded as both being d_{V}, and the horizontal spacing d_{H1} and the horizontal spacing d_{H2} may be regarded as both being d_{H}. The round-trip distance from the transmitting antenna TX₀ to the external object and arriving at the receiving antenna RX₀ during the first transmission and reception period is 2R, the round-trip distance from the transmitting antenna TX₀ to the external object and arriving at the receiving antenna RX₁ during the second transmission and reception period is 2R+d_{H} sin θ+d_{V} sin φ, the round-trip distance from the transmitting antenna TX₁ to the external object and arriving at the receiving antenna RX₁ during the third transmission and reception period is 2R+2d_{H} sin θ, and the round-trip distance from the transmitting antenna TX₁ to the external object and arriving at the receiving antenna RX₀ during the fourth transmission and reception period is 2R+d_{H} sin θ-d_{V} sin φ. The movement information may be obtained from the distance change between the two time points. For example, the phase difference between the radio frequency signal x_{1,4n-3} (t) and the radio frequency signal x_{2,4n-1} (t) in the direction D1 is 2d_{V} sin φ or the phase difference between the radio frequency signal x_{0,4n-4} (t) and the radio frequency signal x_{3,4n-2} (t) in the direction D2 is 2d_{H} sin θ. It is worth noting that there may be changes in the calculation of the round-trip distance due to different relative positions of the external object and the transmitting antenna TX₀, the transmitting antenna TX₁, the receiving antenna RX₀, and the receiving antenna RX₁, but the phase difference obtained by subsequent calculations is the same. For example, in the embodiment of FIG. 2D and the embodiment of FIG. 3, the calculation results of the round-trip distances during the second transmission and reception period are different, and the calculation results of the round-trip distances during the fourth transmission and reception period are different, but the phase differences formed in the direction D1 are both 2d_{V} sin φ.

Alternatively, the computing processor 20 may convert multiple reflected signals into spatial spectrum information to determine angle information. One peak value in the spatial spectrum information corresponds to the angle information. The angle information is, for example, the angle of arrival θ. The angle of arrival (AoA) estimation algorithm is, for example, the multiple signal classification (MUSIC) algorithm, the root-MUSIC algorithm, or the estimation of signal parameters via rotational invariance techniques (ESPRIT) algorithm. The difference 2d_{V} sin φ between the radio frequency signal x_{1,4n-3} (t) and the radio frequency signal x_{2,4n-1} (t) may be used to determine the angle φ, and the difference 2d_{H} sin θ between the radio frequency signal x_{0,4n-4} (t) and the radio frequency signal x_{3,4n-2} (t) may be used to determine the angle of arrival θ. The movement information may also be obtained from angle change between the two time points. In this way, position detection in a three-dimensional space may be achieved. The difference 2d_{V} sin φ in the direction D1 may also be applied to recognition of hand gestures or body postures. Furthermore, the radar system 10 of the embodiment is configured such that there is the vertical spacing d_{V1} between the two transmitting antennas TX₀ and TX₁ in the direction D1, there is the vertical spacing d_{V2} between the two receiving antennas RX₀ and RX₁ in the direction D1, there is the horizontal spacing din between the two transmitting antennas TX₀ and TX₁ in the direction D2, there is the horizontal spacing d_{H2} between the two receiving antennas RX₀ and RX₁ in the direction D2, the vertical spacing d_{V1} and the vertical spacing d_{V2} may be regarded as both being d_{V}, and the horizontal spacing d_{H1} and the horizontal spacing d_{V2} may be regarded as both being d_{H}. Such a configuration manner may generate the vertical phase difference of 2d_{V} sin φ. In other words, in the embodiment, the phase difference in the direction D1 may be increased through the configuration manner of the transmitting antennas and the receiving antennas, so that noise in the signal may be distinguished, thereby reducing the chance of misjudgment in object detection. Furthermore, in addition to the above feature in which the vertical spacing d_{V} between the two transmitting antennas TX₀ and TX₁ and the two receiving antennas RX₀ and RX₁ in the direction D1 generates the phase difference of 2d_{V} sin φ originally, in the embodiment of FIG. 2D and the embodiment of FIG. 3, the transmitting antenna TX₁ and the receiving antenna RX₁ are located at the same level in the direction D1 (that is, the vertical spacing d_{V31} is equal to the vertical spacing d_{V61}, and the vertical spacing d_{V32} is equal to the vertical spacing d_{V62}), and the transmitting antenna TX₀ and the receiving antenna RX₀ are located at the same level in the direction D1 (that is, the vertical spacing d_{V41} is equal to the vertical spacing d_{V51}, and the vertical spacing d_{V42} is equal to the vertical spacing d_{V52}). In this way, compared with the prior art, in the case where the same target phase difference is to be obtained, using the antenna configuration manner in the embodiment of FIG. 2D and the embodiment of FIG. 3 may further reduce the thickness of the radar system 10 in the direction D1.

In an embodiment, the transmitting antenna 12 (for example, the transmitting antenna TX₀ or TX₁) and the receiving antenna 13 (for example, the receiving antenna RX₀ or RX₁) that are conducted/selected/used during one transmission and reception period form one transmission and reception combination. For example, “TX₀+RX₀” corresponding to the first transmission and reception period shown in FIG. 10 represents the transmission and reception combination of the transmitting antenna TX₀ and the receiving antenna RX₀, “TX₀+RX₁” corresponding to the second transmission and reception period represents the transmission and reception combination of the transmitting antenna TX₀ and the receiving antenna RX₁, “TX₁+RX₁” corresponding to the third transmission and reception period represents the transmission and reception combination of the transmitting antenna TX₁ and the receiving antenna RX₁, and “TX₁+RX₀” corresponding to the fourth transmission and reception period represents the transmission and reception combination of the transmitting antenna TX₁ and the receiving antenna RX₀. However, the sequence of the transmission and reception combinations is not limited to the above example. For example, the transmission and reception combination of the first transmission and reception period is “TX₁+RX₀”, the transmission and reception combination of the second transmission and reception period is “TX₁+RX₁”, the transmission and reception combination of the third transmission and reception period is “TX₀+RX₁”, and the transmission and reception combination of the fourth transmission and reception period is “TX₀+RX₀”.

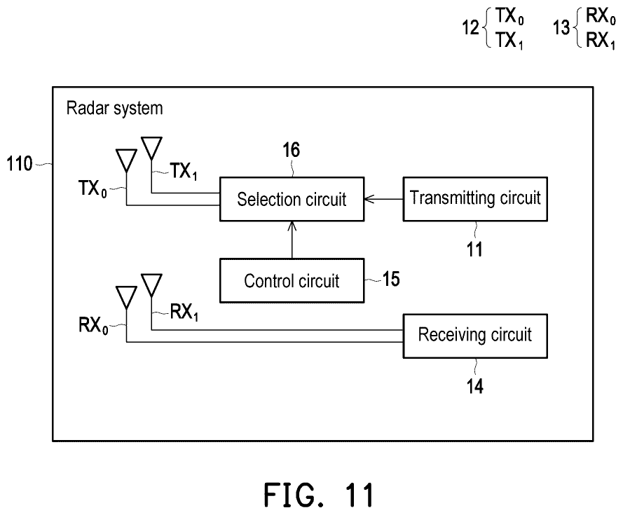

In addition, the disclosure provides another embodiment as shown in FIG. 11. FIG. 11 is a block diagram of elements of a radar system 110 according to an embodiment of the disclosure. Please refer to FIG. 11. The radar system 110 includes (but is not limited to) a transmitting circuit 11, multiple transmitting antennas 12, multiple receiving antennas 13, a receiving circuit 14, a control circuit 15, and a selection circuit 16. The radar system 110 may be, for example, applied to fields such as meteorology, speed measurement, vehicle reversing, terrain, and military affairs.

The transmitting circuit 11 is configured to generate a transmission signal. The transmitting antennas 12 are configured to transmit transmission signals. The receiving antennas 13 are configured to receive multiple reflected signals to form multiple radio frequency signals, and the reflected signals are generated by the transmission signals being reflected by an external object. The receiving circuit 14 is configured to generate internal signals according to the radio frequency signals. The control circuit 15 is configured to generate one or more control signals.

Reference may be respectively made to the descriptions of the corresponding elements in FIG. 1 for the functions and the implementation aspects of the transmitting circuit 11, the transmitting antennas 12, the receiving antennas 13, the receiving circuit 14, the control circuit 15, and the selection circuit 16, which will not be repeated here. The difference from the radar system 10 in FIG. 1 is that the selection circuit 16 of the radar system 110 is only connected to the transmitting antennas 12, but is not connected to the receiving antennas 13. For example, the radar system 110 does not include the switching circuit 162 of FIG. 7. The selection circuit 16 is configured to receive the one or more control signals and is configured to select one of the transmitting antennas 12 to transmit the transmission signal according to the one or more control signals. In the embodiment, one of the transmitting antennas 12 is selected through the selection circuit 16, and the transmitting antennas 12 take turns to generate and transmit the transmission signals in a time-division manner. On the other hand, the receiving antennas (for example, RX₀ and RX₁ to be described later) receive the corresponding reflected signals at the same time.

In addition, in the embodiment, the transmitting antennas 12 include two transmitting antennas TX₀ and TX₁. The receiving antennas 13 include the two receiving antennas RX₀ and RX₁. There is a vertical spacing in a certain direction and a horizontal spacing in another direction between the transmitting antenna TX₀ and the transmitting antenna TX₁. There is a vertical spacing in a certain direction and a horizontal spacing in another direction between the receiving antenna RX₀ and the receiving antenna RX₁. The above two directions are perpendicular to each other. The vertical spacing between the two transmitting antennas TX₀ and TX₁ is equal to the vertical spacing between the two receiving antennas RX₀ and RX₁. The horizontal spacing between the two transmitting antennas TX₀ and TX₁ is equal to the horizontal spacing between the two receiving antennas RX₀ and RX₁. The vertical spacings and the horizontal spacings are all greater than zero, similar to the antenna configurations in FIG. 2A to FIG. 2D and FIG. 3 to FIG. 6, which will not be repeated here.

In summary, in the radar system according to the embodiment of the disclosure, there are spacings between the two transmitting antennas respectively in the two mutually perpendicular directions, and there are also spacings between the two receiving antennas respectively in the two mutually perpendicular directions. Under such an antenna configuration, through switching one of the transmitting antennas and one of the receiving antennas at different times, the corresponding reflected signals between the two times may form a phase difference corresponding to a certain direction or a phase difference corresponding to another direction. In this way, the object detection in the three-dimensional space may be achieved. In the case of being applied to the recognition of hand gestures or body postures, the phase difference in the vertical direction may be increased through the antenna configuration to distinguish the noise in the signal, thereby reducing the chance of misjudgment in the object detection. In addition, in the case where the transmitting antenna TX₀ and the receiving antenna RX₀ are located at the same level in the direction D1, and the transmitting antenna TX₁ and the receiving antenna RX₁ are located at the same level in the direction D1, the thickness of the radar system 10 in the direction D1 may be further reduced. In other embodiments, under the antenna configuration, the object detection in the three-dimensional space may also be achieved by adopting the operation manner of switching one of the transmitting antennas at different times and using the receiving antennas to receive the reflected signals at the same time, and the phase difference in the vertical direction is increased through the antenna configuration to reduce the chance of misjudgment in the object detection.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A radar system, comprising:
a plurality of transmitting antennas, configured to transmit a transmission signal; and
a plurality of receiving antennas, configured to receive a reflected signal to form a radio frequency signal, wherein the reflected signal is generated by the transmission signal being reflected by an external object,
wherein the transmitting antennas comprise a first transmitting antenna and a second transmitting antenna, the first transmitting antenna and the second transmitting antenna are configured to transmit the transmission signal at different times, the receiving antennas comprise a first receiving antenna and a second receiving antenna, the first receiving antenna and the second receiving antenna are configured to receive the reflected signal at different times, there is a first vertical spacing in a first direction and a first horizontal spacing in a second direction between the first transmitting antenna and the second transmitting antenna, there is a second vertical spacing in the first direction and a second horizontal spacing in the second direction between the first receiving antenna and the second receiving antenna, the first direction is perpendicular to the second direction, the first vertical spacing is equal to the second vertical spacing, the first horizontal spacing is equal to the second horizontal spacing, and the first vertical spacing, the second vertical spacing, the first horizontal spacing, and the second horizontal spacing are all greater than zero.

2. The radar system according to claim 1, wherein the first vertical spacing and the first horizontal spacing are respectively a spacing between a shape center of the first transmitting antenna and a shape center of the second transmitting antenna in the first direction and the second direction, and the second vertical spacing and the second horizontal spacing are respectively a spacing between a shape center of the first receiving antenna and a shape center of the second receiving antenna in the first direction and the second direction.

3. The radar system according to claim 1, wherein in the first direction, there is a third vertical spacing between the first transmitting antenna and a reference line, there is a fourth vertical spacing between the second transmitting antenna and the reference line, the third vertical spacing is greater than the fourth vertical spacing, and the reference line is parallel to the second direction.

4. The radar system according to claim 3, wherein in the first direction, there is a fifth vertical spacing between the first receiving antenna and the reference line, there is a sixth vertical spacing between the second receiving antenna and the reference line, and the fifth vertical spacing is less than the sixth vertical spacing.

5. The radar system according to claim 4, wherein the third vertical spacing is equal to the sixth vertical spacing, and the fourth vertical spacing is equal to the fifth vertical spacing.

6. The radar system according to claim 4, wherein the third vertical spacing is greater than the sixth vertical spacing and the fourth vertical spacing is greater than the fifth vertical spacing or the third vertical spacing is less than the sixth vertical spacing and the fourth vertical spacing is less than the fifth vertical spacing.

7. The radar system according to claim 1, wherein the transmitting antennas and the receiving antennas are mirror symmetrical with respect to a symmetry axis, and the symmetry axis is parallel to the first direction.

8. The radar system according to claim 1, wherein the first transmitting antenna and the second transmitting antenna are located on a first plane, and the first receiving antenna and the second receiving antenna are located on a second plane, wherein the first plane is parallel to the second plane, there is a spacing greater than zero between the first plane and the second plane in a third direction, and the third direction is respectively perpendicular to the first direction and the second direction.

9. The radar system according to claim 1, wherein the first vertical spacing is less than or equal to λ/2, the second vertical spacing is less than or equal to λ/2, and λ is a wavelength of the transmission signal.

10. The radar system according to claim 9, wherein the first vertical spacing is greater than or equal to λ/8, and the second vertical spacing is greater than or equal to λ/8.

11. The radar system according to claim 1, wherein the first horizontal spacing is less than or equal to λ/2, the second horizontal spacing is less than or equal to λ/2, and λ is a wavelength of the transmission signal.

12. The radar system according to claim 11, wherein the first horizontal spacing is greater than or equal to λ/8, and the second horizontal spacing is greater than or equal to λ/8.

13. The radar system according to claim 1, wherein the first vertical spacing is less than the first horizontal spacing, and the second vertical spacing is less than the second horizontal spacing.

14. The radar system according to claim 1, further comprising:
a transmitting circuit, configured to generate the transmission signal;
a receiving circuit, configured to generate an internal signal according to the radio frequency signal;
a control circuit, configured to generate one or more control signals, wherein the one or more control signals change corresponding to a period of a first signal, and the first signal is a continuous wave signal or a pulse signal; and
a selection circuit, configured to receive the one or more control signals and configured to select one of the transmitting antennas to transmit the transmission signal according to the one or more control signals, and select one of the receiving antennas to receive the reflected signal to form the radio frequency signal.

15. The radar system according to claim 14, wherein one frame time comprises a plurality of transmission and reception periods, the selection circuit is configured to select only one of the transmitting antennas to transmit the transmission signal during each of the transmission and reception periods in the frame time according to the one or more control signals, and select only one of the receiving antennas to receive the reflected signal during each of the transmission and reception periods in the frame time.

16. The radar system according to claim 15, wherein the frame time comprises a first transmission and reception period, a second transmission and reception period, a third transmission and reception period, and a fourth transmission and reception period, the selection circuit is configured to select the first transmitting antenna and the first receiving antenna during the first transmission and reception period according to the one or more control signals, select the first transmitting antenna and the second receiving antenna during the second transmission and reception period, select the second transmitting antenna and the first receiving antenna during the third transmission and reception period, and select the second transmitting antenna and the second receiving antenna during the fourth transmission and reception period.

17. The radar system according to claim 16, further comprising a computing processor coupled to the receiving circuit, wherein the receiving circuit generates a first internal signal corresponding to the first transmission and reception period, the receiving circuit generates a second internal signal corresponding to the second transmission and reception period, the receiving circuit generates a third internal signal corresponding to the third transmission and reception period, the receiving circuit generates a fourth internal signal corresponding to the fourth transmission and reception period, the internal signal comprises the first internal signal, the second internal signal, the third internal signal, and the fourth internal signal, and the computing processor is configured to determine spatial information of the external object according to the first internal signal, the second internal signal, the third internal signal, and the fourth internal signal, wherein the spatial information comprises movement information in the first direction and the second direction.

18. The radar system according to claim 14, wherein the transmitting circuit further comprises an amplifier, the amplifier is coupled to one of the transmitting antennas via the selection circuit according to the one or more control signals, the receiving circuit further comprises a low-noise amplifier, and the low-noise amplifier is coupled to one of the receiving antennas via the selection circuit according to the one or more control signals.

19. A radar system, comprising:
a transmitting circuit, configured to generate a transmission signal;
a plurality of transmitting antennas, configured to transmit the transmission signal;
a plurality of receiving antennas, configured to receive a reflected signal to form a radio frequency signal, wherein the reflected signal is generated by the transmission signal being reflected by an external object;
a receiving circuit, configured to generate an internal signal according to the radio frequency signal;
a control circuit, configured to generate one or more control signals; and
a selection circuit, configured to receive the one or more control signals and configured to select one of the transmitting antennas to transmit the transmission signal according to the one or more control signals, and select one of the receiving antennas to receive the reflected signal to form the radio frequency signal,
wherein the transmitting antennas comprise a first transmitting antenna and a second transmitting antenna, the receiving antennas comprise a first receiving antenna and a second receiving antenna, there is a first vertical spacing in a first direction and a first horizontal spacing in a second direction between the first transmitting antenna and the second transmitting antenna, there is a second vertical spacing in the first direction and a second horizontal spacing in the second direction between the first receiving antenna and the second receiving antenna, the first direction is perpendicular to the second direction, the first vertical spacing is equal to the second vertical spacing, the first horizontal spacing is equal to the second horizontal spacing, and the first vertical spacing, the second vertical spacing, the first horizontal spacing, and the second horizontal spacing are all greater than zero.

20. A radar system, comprising:
a transmitting circuit, configured to generate a transmission signal;
a plurality of transmitting antennas, configured to transmit the transmission signal;
a plurality of receiving antennas, configured to receive a plurality of reflected signals to form a plurality of radio frequency signals, wherein the reflected signals are generated by the transmission signal being reflected by an external object;
a receiving circuit, configured to generate an internal signal according to the radio frequency signals;
a control circuit, configured to generate one or more control signals; and
a selection circuit, configured to receive the one or more control signals and configured to select one of the transmitting antennas to transmit the transmission signal according to the one or more control signals,
wherein the transmitting antennas comprise a first transmitting antenna and a second transmitting antenna, the receiving antennas comprise a first receiving antenna and a second receiving antenna, there is a first vertical spacing in a first direction and a first horizontal spacing in a second direction between the first transmitting antenna and the second transmitting antenna, there is a second vertical spacing in the first direction and a second horizontal spacing in the second direction between the first receiving antenna and the second receiving antenna, the first direction is perpendicular to the second direction, the first vertical spacing is equal to the second vertical spacing, the first horizontal spacing is equal to the second horizontal spacing, and the first vertical spacing, the second vertical spacing, the first horizontal spacing, and the second horizontal spacing are all greater than zero.
